(19) United States
(12) Patent Application Publication
(10) Pub. No.: US 2003/0079557 A1
(43) Pub. Date: May 1, 2003

(54) Boltless ultrasonic flowmeter transducer mount

(76) Inventor: Gary Allen Tatum, Houston, TX (US)

Correspondence Address: CONLEY ROSE, P.C., P. O. BOX 3267, HOUSTON, TX, 77253-3267, US

(21) Appl. No.: 09/999,857

(22) Filed: Oct. 31, 2001

(51) Int. Cl. G01D 21/00

(52) U.S. Cl. 73/866.5

(57) ABSTRACT

The present invention comprises an improved ultrasonic transducer mount including a transducer holder sleeve, a base attachment sleeve, and a removable mount cover attachment ring. The transducer holder sleeve has an outer surface that engages an extractor tool for removal of the transducer and transducer holder from the mount. The base attachment sleeve has an outer surface that engages a housing for attachment of the transducer mount.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. Field of the Invention

The present invention relates generally to meters that measure the flow of a fluid. More particularly, the present invention relates to ultrasonic meters measuring fluid flow through a pipe. Still more particularly, the present invention relates to a structure for mounting transducers to an ultrasonic flow meter.

2. Description of the Related Art

After a hydrocarbon, such as natural gas, has been removed from the ground, it is often transported from place to place via pipelines. Very often, an owner or operator of a pipeline desires to accurately know how much gas is flowing through the pipeline. For example, where a billion standard cubic feet of natural gas flows through a single pipeline, even small percentage errors can result in serious miscalculations regarding the amount of gas flowing through the pipeline. Further, particular accuracy for the measurement is demanded when gas is changing hands, or “custody”, because custody transfer applications often involve the exchange of money. Even so, an accurate meter is desirable for all phases of gas or fluid production, transportation, and distribution operations, and for off-shore platforms.

In response to the need for accurate gas flow measurement, ultrasonic flowmeters were developed. Ultrasonic flowmeters, also named sonic or acoustic flowmeters, have the potential to greatly improve the accuracy of gas flow measurements. Unlike many other flowmeter technologies, ultrasonic flowmeters are accurate over a large range of flow rates. Because ultrasonic gas flowmeters are non-intrusive, gas flows through the gas pipeline without encountering an increased pressure region. Consequently, considerable savings are achieved because the gas flows more easily in the pipe. In addition, ultrasonic flowmeters also can measure gas flow accurately despite changing gas composition.

FIG. 1 shows a prior art T-slot ultrasonic transducer mount 100. The mount 100 includes a base 130 with a side surface 131 and a flat surface 132. Arcuately located on the base flat surface 132 are cap screw holes 110-113 for receiving cap screws (not shown) respectively. Also located on base flat surface 132 are two jackscrew holes 120, 121 located 180° apart for receiving jackscrews (not shown). The jackscrews are used for removal of the mount from the meter housing. Also located on the base flat surface 132 are two mount cover holes 118, 119 located 180° apart for receiving the mount cover screws (not shown). Extending from the base 130 is a holder sleeve 140. The inner diameter (ID) of the holder sleeve 140 engages a transducer holder that holds a transducer (not shown). On the outer diameter (OD) of holder sleeve 140 are union sleeve threads 151 for engagement with a union nut (not shown). The union nut is part of an extractor tool (not shown) for removal of the transducer holder and transducer.

In operation, the cap screws (not shown) attach the mount 100 to a meter housing (not shown). The transducer and transducer holder are then inserted into the holder sleeve 140. Once inserted, the transducer holder forms a fluid-tight seal at the joint with the holder sleeve. A mount cover (not shown) attaches to the mount base with screws that engage the mount cover holes 118, 119. The mount cover locks the transducer holder in place and prevents inadvertent disassembly during use and electrical connection to the transducer.

For removal of the transducer holder and transducer, first the mount cover is removed. An extractor tool (not shown) is then attached to the transducer mount 100. The extractor tool consists of an extractor tool valve (not shown) and a removable unit for isolation of the transducer holder and transducer from the transducer mount and meter housing. The extractor tool attaches to the transducer mount 100 by the extractor tool valve union nut (not shown) engaging the union sleeve threads 151. Once engaged, the extractor tool makes an fluid-tight seal with a union valve seal. This seal allows removal of the transducer holder and transducer without releasing pressure from the meter housing and pipeline. The transducer and transducer holder are then removed from the holder sleeve 140 through the extractor tool valve and placed in a chamber in the extractor tool removable unit. Once the transducer holder and transducer are removed, the chamber is sealed from the holder sleeve. Once sealed, the transducer and transducer holder can be removed from the extractor tool.

For removal of the transducer mount 100, pressure must be vented from the housing and the cap screws (not shown) must be removed. Jackscrews are then inserted into jackscrew holes 120, 121. As the screws draw into the holes, they engage the meter housing surface. Further drawing the screws into the jackscrew holes forces the mount 100 out of engagement with the meter housing.

The large size of the T-slot transducer mount provides certain drawbacks. Specifically, the current transducer mount of FIG. 1 causes problems with small meter housings. For example, the cast bosses for the very large OD transducer mounts greatly increase the casting weight of the housing casting because of the material needed at each transducer location boss to allow the mount to be attached. The housing transducer location bosses for the very large OD mounts also greatly increase the end to end length of the meter housing. The increased length is a major concern because the bore of the meter must be machined. The ability to machine a small ID over a very long length becomes harder as the length increases. This is true even if the bore is machined from each end. There are also cost issues concerned with the large size transducer mounts because of the large amount of material used.

Another transducer mount is disclosed in the patent application U.S. Ser. No. 09/944,268 entitled “Ultrasonic Flowmeter Transducer Mount” filed Aug. 30, 2001. This transducer mount includes a removable union sleeve with an outer diameter (OD) that engages the inner diameter (ID) of the extractor tool union nut. The union sleeve fits over a holder sleeve on the mount. With a removable union sleeve, the mount base can be smaller in size because less clearance is required around the union sleeve threads for the cap screws that attach the mount base to the meter housing. The mount base, however, still must be attached to the meter housing with the cap screws as in the T-slot design. Also, the mount must have a reliable means for attaching the union sleeve to the holder sleeve.

It would be advantageous to design a transducer mount that is smaller in size than conventional designs, and that can be manufactured more inexpensively. Ideally, the new transducer mount would be compatible with existing extractor tools, transducers, and holders to facilitate a smooth transition to the new mount design. The new transducer mount would also allow for a smaller size meter housing than conventional meter housings. The smaller size meter housing would have a decreased casting weight and a decreased end to end length. It would also be advantageous to locate the transducer ports in the housing in the same location for different pressure rating transducer mounts. It would also be advantageous for the transducer mount to attach easily to the meter housing. Despite the apparent advantages of such a transducer mount, to date no such mount has been commercially introduced.

### SUMMARY OF THE INVENTION

The present invention comprises an improved ultrasonic transducer mount. Unlike prior transducer mounts, the improved transducer mount includes a threaded base sleeve for attachment to the meter housing, a mount base, and a holder sleeve. With the threaded base sleeve, the mount base can be smaller in size. This is because the mount does not require cap screws to attach the mount base to the meter housing. With the mount base smaller, the mount cover is too big for direct attachment. To attach the mount cover, a mount cover ring connects to the holder sleeve. The mount cover ring has screw holes for attachment of the mount cover by the mount cover screws.

The reduced mount size reduces cost by reducing the material needed. The reduced size also saves manufacturing costs with the ability to be investment cast. The smaller transducer mount decreases the casting weight of the housing with the use of smaller housing transducer location bosses. The smaller transducer mount decreases the end to end length of the small size meter housing. The smaller transducer mount allows the transducer ports to be situated in the same housing location, regardless of the pressure rating. The smaller transducer mount, however, it still compatible with existing transducers and transducer holders.

Thus, the present invention comprises a combination of features and advantages which enable it to overcome various problems of prior devices. The various characteristics described above, as well as other features, will be readily apparent to those skilled in the art upon reading the following detailed description of the preferred embodiments of the invention, and by referring to the accompanying drawings.

### BRIEF DESCRIPTION OF THE DRAWINGS

For a more detailed description of the preferred embodiment of the present invention, reference will now be made to the accompanying drawings, wherein:

FIG. 1 is an illustration of a prior art transducer mount;

FIG. 2A is a cross-sectional side view of a transducer mount constructed in accordance with the preferred embodiment;

FIG. 2B is a cross-sectional side view of a mount cover ring constructed in accordance with the preferred embodiment;

FIG. 2C is a top view of the outer perimeter of the transducer mount base constructed in accordance with the preferred embodiment;

FIG. 3 is a perspective view of the mount constructed in accordance with the preferred embodiment with the mount cover ring attached and the mount cover shown;

FIG. 4 is a cross-sectional view of the mount constructed in accordance with the preferred embodiment with the extractor tool attached; and

FIG. 4A is a perspective view of the mount constructed in accordance with the preferred embodiment with the extractor tool attached.

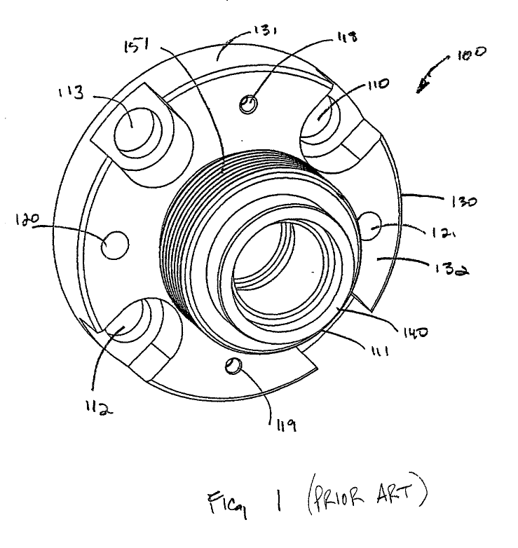

### DETAILED DESCRIPTION OF THE PREFERRED EMBODIMENT

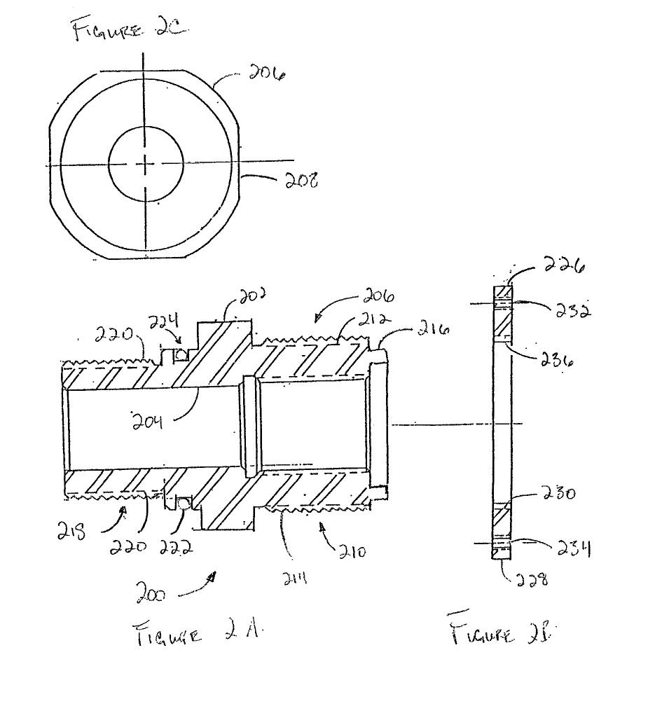

Referring initially to FIGS. 2A, 2B, and 2C, transducer mount 200 constructed in accordance with the preferred embodiment will now be described. The mount 200 comprises a substantially cylindrical base 202 that is received in a meter housing (not shown). The base 202 includes an inner bore 204 that extends from one end of the mount to the other. The inner bore 204 has a diameter that is substantially constant. The base inner bore 204 sealingly receives the transducer holder and transducer (not shown) during operation. The base 202 includes an outer surface 206.

The transducer and transducer holder are inserted into a mount holder sleeve 210 that extends from the mount base 202. The holder sleeve 210 includes an outer surface 212. The holder sleeve outer surface 212 has extractor tool threads 214 that engage the inner surface threads of the union nut (not shown) of the extractor tool valve during removal of the transducer and transducer holder. The holder sleeve seal surface 216 provides a seal surface for the extractor tool union valve seal (not shown).

The mount 200 also includes a base sleeve 218 with an outer surface 220. The base sleeve outer surface 220 includes threads 220 for attaching the base to the meter housing. During operation, the mount 200 forms a fluid-tight seal with the meter housing with an o-ring seal 222 positioned in a groove 224. Referring specifically to FIG. 2C, the base outer surface 206 includes four flat surfaces 208 for engagement with a tool such as a wrench for threading the mount 200 into the meter housing.

Referring now specifically to FIG. 2B, a mount cover attachment ring 226 constructed in accordance with the preferred embodiment will now be discussed. Mount cover attachment ring 226 has an outer surface 228 and an inner surface 230. The attachment ring also has mount cover ring holes 232, 234 for receiving mount cover attachment screws (not shown). Previous-style mount covers require mount cover holes at a certain distance apart to receive the mount cover screws for attaching the mount cover to the mount. With the mount 200 being smaller in size compared to previous mounts, the mount cover attachment ring 226 provides the mount cover ring holes 232,234 at the same distance apart as the previous mounts. The inner surface 230 of the attachment ring 226 also has threads 236 that engage the extractor tool threads 214 on the holder sleeve outer surface 212. For attachment, ring 226 is threaded onto the holder sleeve outer surface 212.

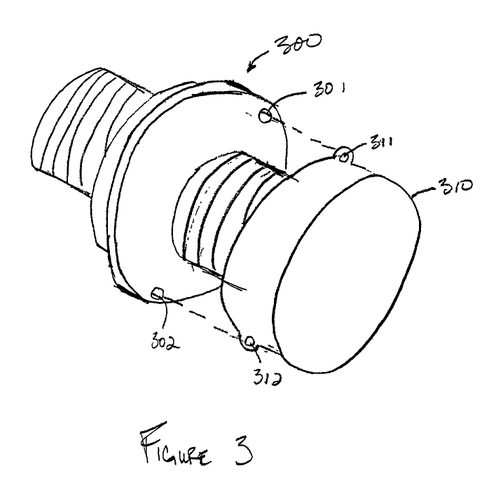

Referring now to FIG. 3, transducer mount 300 and transducer mount cover 310 constructed in accordance with the preferred embodiment will now be described. The transducer mount cover 310 holds the transducer holder in place on the meter housing (not shown) and prevents inadvertent disassembly during use. The transducer mount cover 310 includes two holes 311, 312 located 180° apart on the edge of the cover 310. Screws attach the cover 310 to the mount 300 by engaging the mount cover holes 311, 312 and the mount cover ring holes 301, 302.

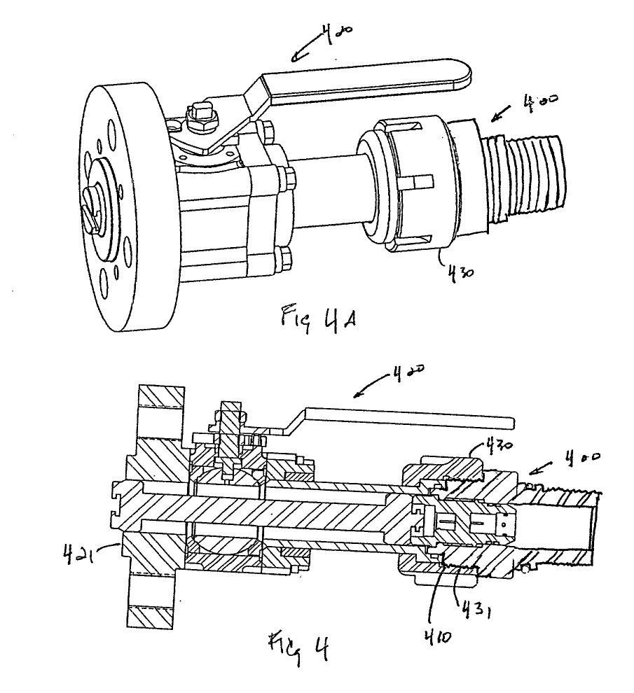

Referring now to FIGS. 4 and 4A, transducer mount 400 and extractor tool valve 420 constructed in accordance with the preferred embodiment will now be described. The extractor tool valve 420 has a union nut 430 disposed on one end. The union nut 430 has internal threads 431 and attaches to the holder sleeve 410 by threading the union nut 430 onto the holder sleeve 410. Once threaded, the union nut 430 and holder sleeve 410 form a fluid-tight seal. This seal allows removal of the transducer holder and transducer without releasing pressure from the meter housing and pipeline. For removal, the transducer and transducer holder are extracted from the mount 400 through the extractor tool valve 420 and into a chamber in the extractor tool removable unit (not shown) that attaches to flange 421 on extractor tool valve 420. Once the transducer holder and transducer are removed and placed in the removable unit, the chamber is sealed from the mount 400. The transducer and transducer holder can then be removed from the extractor tool valve 420.

While preferred embodiments of this invention have been shown and described, modifications thereof can be made by one skilled in the art without departing from the spirit or teaching of this invention. The embodiments described herein are exemplary only and are not limiting. Many variations and modifications of the system and apparatus are possible and are within the scope of the invention. Accordingly, the scope of protection is not limited to the embodiments described herein, but is only limited by the claims which follow, the scope of which shall include all equivalents of the subject matter of the claims.

What is claimed is:

1. A transducer mount comprising a base, a first sleeve extending from the base in a first direction, a second sleeve extending from the base in a second direction, and a removable ring engagable with the first sleeve.

2. The transducer mount of claim 1 wherein the transducer mount further includes a first sleeve inner bore for receiving a transducer and transducer holder, a first sleeve outer surface for optionally attaching the removable ring or an extractor tool, a first sleeve outer edge, a second sleeve inner bore for receiving the transducer and transducer holder, a second sleeve outer surface for attachment of the mount to a housing, and a second sleeve outer edge.

3. The transducer mount of claim 2 wherein the first sleeve inner bore and the second sleeve inner bore connect forming a cavity extending from the first sleeve outer edge and the second sleeve outer edge.

4. The transducer mount of claim 1 wherein the removable ring further includes at least one screw hole for attachment of a mount cover.

5. The transducer mount of claim 2 wherein the removable ring further includes an inner bore with screw threads that match screw threads on the first sleeve outer surface for attaching the removable ring.

6. The transducer mount of claim 5 wherein the first sleeve screw threads further allow the attachment of the extractor tool for removing the transducer and the transducer holder from the first sleeve inner bore.

7. The transducer mount of claim 2 wherein the second sleeve outer surface further includes screw threads for attaching the mount to a housing.

8. The transducer mount of claim 2 wherein the second sleeve outer diameter further includes a seal for forming a fluid-tight seal with a housing.

9. A transducer mount comprising:
a base with a first sleeve extending from the base in a first direction, a second sleeve extending from the base in a second direction, and a removable ring engagable with the first sleeve;
a first sleeve inner bore for receiving a transducer and transducer holder, a first sleeve outer surface for optionally attaching the removable ring or an extractor tool, a first sleeve outer edge, a second sleeve inner bore for receiving the transducer and transducer holder, a second sleeve outer surface for attachment of the mount to a housing, and a second sleeve outer edge;
wherein the first sleeve further includes screw threads for attachment of an extractor tool for removing a transducer and a transducer holder from the first sleeve inner bore;
wherein the second sleeve outer surface further includes screw threads for attaching the mount to a housing; and
wherein the second sleeve outer surface further includes a seal for forming a fluid-tight seal with the housing.

10. The transducer mount of claim 9 wherein the removable ring further includes at least one screw hole for attachment of a mount cover.

11. The transducer mount of claim 9 wherein the removable ring further includes an inner bore with screw threads that match screw threads on the first sleeve outer surface for attaching the removable ring.

12. A transducer mount comprising a base, a removable ring, a means for attaching the removable ring, a means for receiving a transducer and transducer holder, and a means for attaching the mount to a housing.

13. The transducer mount of claim 12 wherein the means for attaching the removable ring further allows the attachment of an extractor tool for removing the transducer and transducer holder from the base.

14. The transducer mount of claim 12 wherein the means for attaching the mount to the housing further includes a means for forming a fluid-tight seal with the housing.

15. The transducer mount of claim 12 wherein the removable ring further includes a means for attaching a mount cover.
